(19) United States
(12) Patent Application Publication
(10) Pub. No.: US 2024/0152658 A1
(43) Pub. Date: May 9, 2024

(54) SYSTEMS AND METHODS FOR ACCESS PROTECTION OF SYSTEM PERIPHERALS

(71) Applicant: Cirrus Logic International Semiconductor Ltd., Edinburgh (GB)

(72) Inventors: Younes DJADI, Austin, TX (US); Xingdong DAI, Austin, TX (US); Nathan BUCHANAN, Austin, TX (US); Nariankadu D. HEMKUMAR, Austin, TX (US)

(73) Assignee: Cirrus Logic International Semiconductor Ltd., Edinburgh (GB)

(21) Appl. No.: 18/500,876

(22) Filed: Nov. 2, 2023

Related U.S. Application Data
(60) Provisional application No. 63/423,684, filed on Nov. 8, 2022.

(51) Int. Cl. G06F 21/85; G06F 11/07; G06F 11/14; G06F 21/60

(52) U.S. Cl. CPC G06F 21/85; G06F 11/0772; G06F 11/1441; G06F 21/604

(57) ABSTRACT

A system may include a plurality of processing cores, a target shared among the plurality of processing cores and coupled to the plurality of processing cores via a shared bus, and access control logic configured to, based on access configuration settings associated with the target, control access of requests from each of the plurality of processing cores based on a privilege level of each of the plurality of processing cores, in order to dynamically allocate and re-allocate the target among the plurality of processing cores in accordance with the privilege levels and to dynamically utilize the target in accordance with the privilege levels.

### RELATED APPLICATION

This application claims priority to U.S. Provisional Application Ser. No. 63/423,684, filed Nov. 8, 2022, which is incorporated by reference herein in its entirety.

### FIELD OF DISCLOSURE

The present disclosure relates in general to circuits for electronic devices, including without limitation personal portable devices such as wireless telephones and media players, and more specifically, systems and methods for access protection of system peripherals in a multicore processing device and/or between multiple processing devices.

### BACKGROUND

Many mobile devices (e.g., mobile phones) include one or more cameras for capturing images. To provide for image stabilization and focus, a position of a camera within a plane substantially parallel to a subject of an image as well as a position of a lens of the camera in a direction perpendicular to such plane, may be controlled by a plurality of motors under the control of a camera controller. A control system may be implemented using an applications processor of the mobile device coupled via a communication interface (e.g., an Inter-Integrated Circuit or I2C interface) to a camera controller local to the camera and its various motors. For example, the applications processor may communicate to the camera controller a vector of data regarding a target position for an applications processor, whereas the camera controller may communicate to the applications processor a vector regarding an actual position of the camera, as sensed by a plurality of magnetic sensors (e.g., Hall sensors) and/or other appropriate sensors.

As mobile devices become more sophisticated, so too is camera control on such mobile devices. Accordingly, camera controllers are increasingly being implemented using multicore processors that may include, on a single integrated circuit, a plurality of processing cores and a plurality of peripheral blocks. A multicore implementation may enable improved system performance (e.g., more operations per clock cycle) and/or may enable execution of processing cores at a lower clock frequency. In addition to use in camera controllers, multicore processors find use in other computation-intensive applications. In addition, camera controllers may also be implemented using multiple processing cores spread over a plurality of integrated circuits.

In many implementations of multicore processors, a number of peripheral devices (e.g., timers, interrupt controllers, memories, data engines, etc.) may be directly attached to a shared bus system along with the processing cores, sometimes on the same integrated circuit package. Bus controllers (e.g., processors, Inter-Integrated Circuit (I2C), Serial Peripheral Interface (SPI), etc.) typically use different addresses to communicate with peripherals attached to the shared bus. Shared bus systems are widely used in many applications employing embedded processors, due to simpler and smaller designs (i.e., reduced area and cost), higher resource utilization for peripherals, and improved overall system performance (e.g., reduced duplication in shared storage resources such as memory and registers).

Despite these advantages, the use of a shared bus architecture may have challenges and disadvantages. For example, when a bus-attached peripheral is shared, usage conflict may arise if not managed properly, because the peripheral may be modified by any one of the bus controllers in a multicore system. In particular, it may be vital that system critical peripherals can only be modified by trusted cores while non-critical/shared peripherals may be accessed by any core. Additionally, either autonomously and/or under external supervision/direction by a host controller, and under various contexts/state evolution including for both normal and/or pathology driven reasons, a multicore system may need to dynamically allocate/re-allocate ownership and utilization thereof of aforementioned shared peripherals/system components.

One existing approach for avoiding resource conflict is to use a private bus for some system peripherals. However, such configuration makes the overall system less efficient. The private peripherals are frequently under-utilized, and the overall system often requires duplication of peripheral modules to support different modes of chip functions. These deficiencies may lead to larger die area, hence higher power consumption and higher cost, which are undesirable in consumer and mobile applications. In addition, a private bus does not scale well and may complicate future programmability and design expansion.

Accordingly, a better approach for resource management of system peripherals in a multi-core and multi-chip system, in particular with regard to access control (security) and improved resource utilization, is desired.

### SUMMARY

In accordance with the teachings of the present disclosure, certain disadvantages and problems associated with existing approaches to managing access to system peripherals in multicore systems may be reduced or eliminated.

In accordance with embodiments of the present disclosure, a system may include a plurality of processing cores, a target shared among the plurality of processing cores and coupled to the plurality of processing cores via a shared bus, and access control logic configured to, based on access configuration settings associated with the target, control access of requests from each of the plurality of processing cores based on a privilege level of each of the plurality of processing cores, in order to dynamically allocate and re-allocate the target among the plurality of processing cores in accordance with the privilege levels and to dynamically utilize the target in accordance with the privilege levels.

In accordance with these and other embodiments of the present disclosure, a method may include, in a system comprising a plurality of processing cores and a target shared among the plurality of processing cores and coupled to the plurality of processing cores via a shared bus, controlling access of requests from each of the plurality of processing cores based on a privilege level of each of the plurality of processing cores based on access configuration settings associated with the target, in order to dynamically allocate and re-allocate the target among the plurality of processing cores in accordance with the privilege levels and to dynamically utilize the target in accordance with the privilege levels.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the example, present embodiments and certain advantages thereof may be acquired by referring to the following description taken in conjunction with the accompanying drawings, in which like reference numbers indicate like features, and wherein:

FIG. 1 illustrates a block diagram of selected components of an example mobile device, in accordance with embodiments of the present disclosure; and

FIG. 2 illustrates a block diagram of selected components of an example multicore processor which may be used to implement a control subsystem of a camera controller, in accordance with embodiments of the present disclosure.

### DETAILED DESCRIPTION

In accordance with embodiments of the present disclosure, an access control system may use a global system configuration register implemented for peripheral access control (security) and resource partition. Access control may include control of a protection bit that enables protection for each device peripheral on a peripheral-by-peripheral basis. When this protection bit is set, an access to a protected peripheral from any non-trusted cores may be blocked and a bus error may be issued.

The access control system may also perform resource management, which may be an extension of access control. Resource management may include using a controller identifier (e.g., core identifier) register field for each device peripheral. When a shared resource is available (i.e., unclaimed, for example at system start up), the controller identifier value may be 0. A controller (e.g., core) may claim available resources by writing its controller identifier (or group identifier based on device management policy) into this controller identifier register field and peripheral access control may be updated accordingly.

A peripheral may be claimed as a whole, for example, both its system timer and data engines. Alternatively, a peripheral may be claimed by parts, for example, shared memory in fixed or programmable sizes.

For example, in some embodiments, a first processor core may be designated as primary and trusted with device configuration including access control and resource management, while a second processor may be designated as secondary and mainly intended for data computation tasks. At boot time, the primary core may update resource management policy, including peripheral access protection. The distinction between cores may be based on the privilege level of the core (or core identifier in a multicore implementation, multichip implementation, and/or a multiple bus manager implementation). If the core identifier match of the core privilege is high enough, write access to a peripheral may be granted (in some embodiments, a core identifier itself may convey a privilege level). Otherwise, write access to a peripheral may be denied and a bus error is returned.

A core privilege mode is typically controlled by the software running on the trusted core, but may also be fixed by the hardware implementation. By default in some embodiments, only the trusted core may access the system configuration. A system configuration register may also be protected by a write lock key, to prevent unintentional writes.

Dynamic allocations/re-allocations of shared peripherals/system components between and among the cores in a multicore system may be achieved via software/hardware using mechanisms such as inter-processor communication (IPC) and mutex primitives to implement protocols facilitating exclusive ownership by trusted/designated cores and handoffs of the same amongst themselves as determined autonomously and/or under external supervision/direction by a host controller under various contexts/state evolution including for both normal and/or pathology driven reasons.

In some implementations, only write access may be controlled. In addition or alternatively, in other implementations, access control may extend to read access protection as well, for example if peripheral settings and/or peripheral contents are of high security concern.

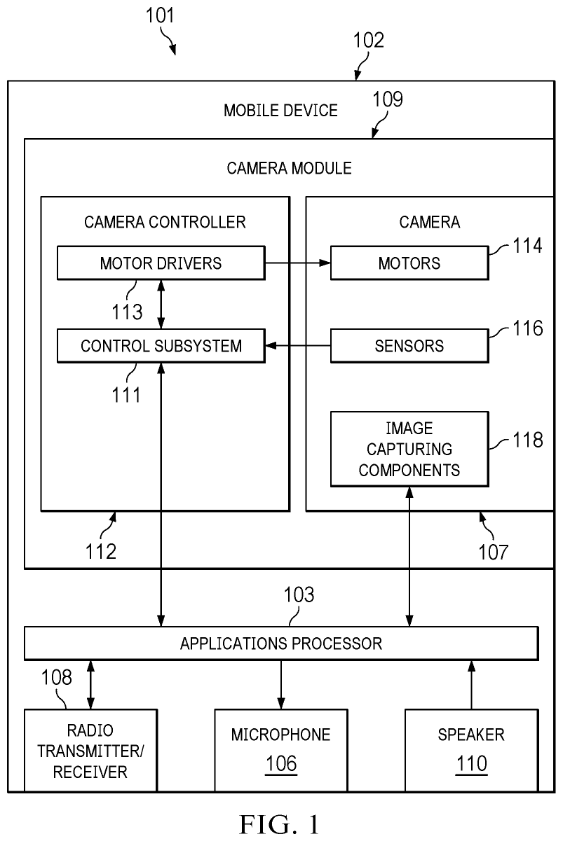

FIG. 1 illustrates a block diagram of selected components of an example mobile device 101, in accordance with embodiments of the present disclosure. As shown in FIG. 1, mobile device 101 may comprise an enclosure 102, an applications processor 103, a microphone 106, a radio transmitter/receiver 108, a speaker 110, and a camera module 109 comprising a camera 107 and a camera controller 112.

Enclosure 102 may comprise any suitable housing, casing, or other enclosure for housing the various components of mobile device 101. Enclosure 102 may be constructed from plastic, metal, and/or any other suitable materials. In addition, enclosure 102 may be adapted (e.g., sized and shaped) such that mobile device 101 is readily transported on a person of a user of mobile device 101. Accordingly, mobile device 101 may include but is not limited to a smart phone, a tablet computing device, a handheld computing device, a personal digital assistant, a notebook computer, a video game controller, or any other device that may be readily transported on a person of a user of mobile device 101.

Applications processor 103 may be housed within enclosure 102 and may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, applications processor 103 may interpret and/or execute program instructions and/or process data stored in a memory (not explicitly shown) and/or other computer-readable media accessible to applications processor 103.

Microphone 106 may be housed at least partially within enclosure 102, may be communicatively coupled to applications processor 103, and may comprise any system, device, or apparatus configured to convert sound incident at microphone 106 to an electrical signal that may be processed by applications processor 103, wherein such sound is converted to an electrical signal using a diaphragm or membrane having an electrical capacitance that varies based on sonic vibrations received at the diaphragm or membrane. Microphone 106 may include an electrostatic microphone, a condenser microphone, an electret microphone, a microelectromechanical systems (MEMs) microphone, or any other suitable capacitive microphone.

Radio transmitter/receiver 108 may be housed within enclosure 102, may be communicatively coupled to applications processor 103, and may include any system, device, or apparatus configured to, with the aid of an antenna, generate and transmit radio-frequency signals as well as receive radio-frequency signals and convert the information carried by such received signals into a form usable by applications processor 103. Radio transmitter/receiver 108 may be configured to transmit and/or receive various types of radio-frequency signals, including without limitation, cellular communications (e.g., 2G, 3G, 4G, LTE, etc.), short-range wireless communications (e.g., BLUETOOTH), commercial radio signals, television signals, satellite radio signals (e.g., GPS), Wireless Fidelity, etc.

Speaker 110 may be housed at least partially within enclosure 102 or may be external to enclosure 102, may be communicatively coupled to applications processor 103, and may comprise any system, device, or apparatus configured to produce sound in response to electrical audio signal input. In some embodiments, speaker 110 may comprise a dynamic loudspeaker, which employs a lightweight diaphragm mechanically coupled to a rigid frame via a flexible suspension that constrains a voice coil to move axially through a magnetic gap. When an electrical signal is applied to the voice coil, a magnetic field is created by the electric current in the voice coil, making it a variable electromagnet. The voice coil and the driver's magnetic system interact, generating a mechanical force that causes the voice coil (and thus, the attached cone) to move back and forth, thereby reproducing sound under the control of the applied electrical signal coming from the amplifier.

Camera 107 may be housed at least partially within enclosure 102 (and partially outside of enclosure 102, to enable light to enter a lens of camera 107), and may include any suitable system, device, or apparatus for recording images (moving or still) into one or more electrical signals that may be processed by applications processor 103. As shown in FIG. 1, camera 107 may include a plurality of motors 114, sensors 116, and image capturing components 118.

Image capturing components 118 may include a collection of components configured to capture an image, including without limitation one or more lenses and image sensors for sensing intensities and wavelengths of received light. Such image capturing components 118 may be coupled to applications processor 103 such that camera 107 may communicate captured images to applications processor 103.

Motors 114 may be mechanically coupled to one or more of image capturing components 118 and each motor 114 may include any suitable system, device, or apparatus configured to, based on control signals received from camera controller 112 indicative of a desired camera position, cause mechanical motion of such one or more image capturing components 118 to a desired camera position.

Sensors 116 may be mechanically coupled to one or more of image capturing components 118 and/or motors 114 and may be configured to sense a position associated with camera 107. For example, a first sensor 116 may sense a first position (e.g., x-position) of camera 107 with respect to a first linear direction, a second sensor 116 may sense a second position (e.g., y-position) of camera 107 with respect to a second linear direction normal to the first linear direction, and a third sensor 116 may sense a third position (e.g., z-position) of camera 107 (e.g., position of lens) with respect to a third linear direction normal to the first linear direction and the second linear direction.

Camera controller 112 may be housed within enclosure 102, may be communicatively coupled to camera 107 and applications processor 103 (e.g., via an Inter-Integrated Circuit (I2C) interface), and may include any system, device, or apparatus configured to control motors 114 or other components of camera 107 to place components of camera 107 into a desired position. Camera controller 112 may also be configured to receive signals from sensors 116 regarding an actual position of camera 107 and/or regarding a status of camera 107. As shown in FIG. 1, camera controller 112 may include a control subsystem 111 and motor drivers 113.

Control subsystem 111 may be integral to camera controller 112, and may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, control subsystem 111 may interpret and/or execute program instructions and/or process data stored in a memory and/or other computer-readable media accessible to control subsystem 111. Specifically, control subsystem 111 may be configured to perform functionality of camera controller 112, including but not limited to control of motors 114 and receipt and processing of data from sensors 116. In some embodiments, control subsystem 111 may comprise a multicore processor.

Motor drivers 113 may comprise a plurality of circuits, each such circuit configured to receive one or more control signals from control subsystem 111 (including without limitation a signal indicative of a desired target current for a motor 114) and drive a driving signal (e.g., a current-mode signal) to a respective motor 114 in accordance with the one or more control signals in order to control operation of such respective motor 114.

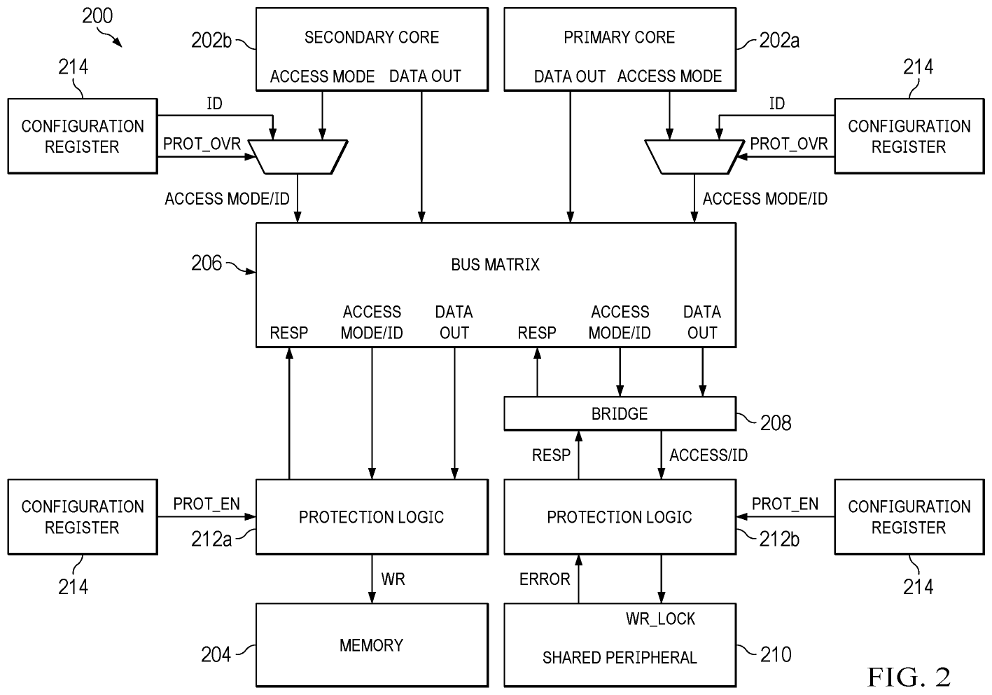

FIG. 2 illustrates a block diagram of selected components of an example multicore processor 200 which may be used to implement control subsystem 111 of camera controller 112, in accordance with embodiments of the present disclosure. As shown in FIG. 2, multicore processor 200 may include a plurality of cores 202 including a primary core 202a and a secondary core 202b, a memory 204, a bus matrix 206, a bridge 208, a shared peripheral 210, protection logic 212 (e.g., protection logic 212a and 212b), and configuration register 214.

Although FIG. 2 depicts only two cores 202 for the purposes of clarity and exposition, it is understood that multicore processor 200 may include any suitable number of cores 202 and/or controllers. In addition, it is understood that in some embodiments, cores 202 may be on separate controllers. Further, although FIG. 2 depicts only a single shared peripheral 210 for the purposes of clarity and exposition, it is understood that multicore processor 200 may include a plurality of shared peripherals 210.

Each core 202 may comprise a separate processing unit, which may read and execute program instructions, such that multicore processor 200 may execute instructions on multiple cores 202 at the same time, which may increase overall execution speed for programs of instructions that support multithreading or other parallel computing techniques. In some embodiments, a core 202 may interpret and/or execute program instructions and/or process data stored in one or more memories 204 and/or another component of multicore processor 200.

A memory 204 may be communicatively coupled to cores 202 via bus matrix 206 and may include any system, device, or apparatus configured to retain program instructions and/or data for a period of time (e.g., computer-readable media). A memory 204 may include RAM, EEPROM, a PCMCIA card, flash memory, magnetic storage, opto-magnetic storage, or any suitable selection and/or array of volatile or non-volatile memory.

Bus matrix 206 may include any suitable communications bus for communicatively coupling cores 202, memory 204, and bridge 208 to one another. In some embodiments, bus matrix 206 may comprise an Advanced High-performance Bus (AHB) in accordance with the Advanced Microcontroller Bus Architecture (AMBA) specification.

Bridge 208 may comprise a peripheral bus interface configured to communicatively couple shared peripheral 210 to a core 202 via bus matrix 206. In some embodiments, a bridge 208 may comprise an Advanced Peripheral Bus (APB) bridge in accordance with the Advanced Microcontroller Bus Architecture specification.

Shared peripheral 210 may include any auxiliary block of multicore processor 200 that may receive information from cores 202 and/or transmit information to cores 202. For example, shared peripheral 210 may in effect comprise an input/output interface of multicore processor 200 that may interface with components external to multicore processor 200, for example motors 114, sensors 116, and/or applications processor 103.

Protection logic 212 may include any system, device, or apparatus configured to, based on access control signals from configuration register 214 and identifier information communicated from bus matrix 206 associated with a core 202 requesting an operation (e.g., write request, read request) to memory 204 (protection logic 212a) or shared peripheral 210 (protection logic 212b), determine whether to permit such request.

Configuration register 214 may comprise any system, device, or apparatus configured to maintain access control settings for each target (e.g., memory 204, shared peripheral 210, etc.) of multicore processor 200. For example, configuration register 214 may maintain a protection override bit PROT_OVR for each target (e.g., memory 204, shared peripheral 210) that indicates whether a configuration register 214 overrides an access mode (e.g., privileged access or non-privileged access) for requests to such target (as indicated by an ACCESS MODE output of a core 202) from controllers or allows such controllers to perform access control in accordance with the access mode. As another example, configuration register 214 may maintain a protection enable bit for each target to indicate whether write protection is enabled for memory 204, shared peripheral 210, and/or other target. As a further example, configuration register 214 may maintain a controller identifier ID for each core 202 or other controller. Such access control settings may be set in any suitable manner, including via a system configuration module of an operating system executing on primary core 202a.

Although for purposes of clarity and exposition, configuration register 214 is shown in FIG. 2 in multiple instantiations, configuration register 214 may be implemented within registers of a single memory device.

In operation, a core 202 may issue a request (e.g., a write request including data to be written via DATA OUT) and an access mode (e.g., privileged/non-privileged) of the request. In some embodiments, the access mode may be indicated by a single bit implemented using an HPROT[1] interface signal in accordance with the AMBA specification. In embodiments using a multi-bit core identifier, side band signals may be used to convey core identifier information along with address information.

If protection override for the target of the request is enabled as indicated by protection override bit PROT_OVR maintained by configuration register 214, then the access mode indicated by a core 202 may be overridden by a controller identifier ID for such core 202 as set forth in configuration register 214. For example, if protection override bit PROT_OVR is set for such peripheral, and controller identifier ID for a core 202 is set for such peripheral, then such core 202 and requests from such core to the target may be privileged regardless of the access mode indicated by the requesting core 202. As another example, if protection override bit PROT_OVR for the target is set, and controller identifier ID for a core 202 is not set for the target, then such core 202 requests from such core to the target may be non-privileged regardless of the access mode indicated by the requesting core 202. The logic truth table set forth below may summarize such functionality:

| PROT_OVR | ID | FUNCTION |
|---|---|---|
| 0 | X | Privilege set by ACCESS MODE from core 202 |
| 1 | 0 | Core 202 and requests therefrom are non-privileged |
| 1 | 1 | Core 202 and requests therefrom are privileged |

Similarly, for requests to memory 204, shared peripheral 210, and/or other request targets, protection logic 212 may, based on settings in configuration register 214 related to such target, determine whether to allow a request to such target. For example, if protection enable bit PROT_EN maintained by configuration register 214 is not set for such target, then both privileged and unprivileged requests may be allowed to the target. On the other hand, if protection enable bit PROT_EN maintained by configuration register 214 is set for the target, then whether the request is allowed may be determined by controller identifier ID of the requesting core 202 if protection override is enabled as indicated by protection override bit PROT_OVR or determined by access mode of the request if protection override is disabled as indicated by protection override bit PROT_OVR. In FIG. 2, signals labeled ACCESS MODE/ID may take on the value of access mode of the request if protection override is disabled and take on the value of controller identifier ID of the requesting core 202 if protection override is enabled. In some embodiments, the ACCESS MODE/ID signal may be indicated by a single bit implemented using a PPROT[1] interface signal in accordance with the AMBA specification.

The logic truth table set forth below may summarize such functionality of protection logic 212:

| | ACCESS | |
|---|---|---|
| PROT_EN | MODE/ID | FUNCTION |
| 0 | X | Privileged and non-privileged access allowed |
| 1 | 0 | Only non-privileged access allowed |
| 1 | 1 | Only privileged access allowed |

In the event access is not allowed to a non-privileged core 202 to a target, protection logic 212 may respond to the non-privileged core 202, via bus matrix 206, with a bus error message regarding the disallowance of the request. For example, protection logic 212 may communicate an interrupt to cores 202 to communicate the bus error message. Such interrupt may be communicated to the privileged core 202 and to a host device via any suitable communication protocol, including without limitation I2C or master state machine (MSM) protocol. In some embodiments, the privileged core 202 may cause multicore processor 200 to shut down in response to the bus error as a safety measure.

Although the foregoing contemplates use of a multicore processor in the context of a camera controller, it is understood that the systems and methods described herein may be applied to any suitable application.

Further, although the foregoing contemplates access control on a single integrated circuit implementing a multicore processor, the systems and methods described herein may be applied to access control for a request by a core/controller on one multicore processor to a target on another multicore processor, so as to allow or restrict access to a target on a first multicore processor from a core/controller on a second multicore processor. In such a multiple integrated circuit system, one or more cores on a primary integrated circuit may give access to all memories and peripherals on a second integrated circuit, via an inter-chip communications link. A privilege level of the secondary device may normally be controlled by the primary device, but such privilege level may also be overwritten by the secondary device. In operation, a core of the primary integrated circuit may, via a bus fabric of the primary integrated circuit, communicate a core identifier and/or privilege level of the bus manager of the primary integrated circuit to the second integrated circuit over the inter-chip communications link, along with requested access information (e.g., address, read/write, etc.).

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A system comprising:
a plurality of processing cores;
a target shared among the plurality of processing cores and coupled to the plurality of processing cores via a shared bus; and
access control logic configured to, based on access configuration settings associated with the target, control access of requests from each of the plurality of processing cores based on a privilege level of each of the plurality of processing cores, in order to dynamically allocate and re-allocate the target among the plurality of processing cores in accordance with the privilege levels and to dynamically utilize the target in accordance with the privilege levels.

2. The system of claim 1, wherein the plurality of processing cores, the target, and the access control logic are fabricated within the same multicore processor integrated circuit.

3. The system of claim 1, wherein at least one of the processing cores and the target are fabricated on different integrated circuits.

4. The system of claim 3, wherein:
the target is fabricated on a first integrated circuit;
a processing core is fabricated on a second integrated circuit coupled to the first integrated circuit via an inter-chip communications link; and
the first integrated circuit and the second integrated circuit are configured such that a privilege level of the second integrated circuit is controlled by the first integrated circuit and such that the second integrated circuit is able to overwrite the privilege level.

5. The system of claim 1, wherein controlling access of requests from each of the plurality of processing cores based on the privilege level of each of the plurality of processing cores comprises controlling access from at least one processing core of the plurality of processing cores to the target based on an access mode of the at least one processing core.

6. The system of claim 1, wherein the access control logic may be configured to override an access mode of at least one processing core of the plurality of processing cores with at least one other access control parameter and wherein controlling access of requests from each of the plurality of processing cores based on the privilege level of each of the plurality of processing cores comprises controlling access from the at least one processing core based on the at least one other access control parameter.

7. The system of claim 1, wherein controlling access of requests from each of the plurality of processing cores based on the privilege level of each of the plurality of processing cores comprises controlling access from at least one processing core of the plurality of processing cores to the target based on an identifier of the at least one processing core.

8. The system of claim 1, wherein the access control logic is further configured to generate an error signal responsive to disallowing a request from a processing core to the target in accordance with the access configuration settings.

9. The system of claim 8, wherein the access control logic may generate the error signal as an interrupt to one or more of the plurality of processing cores.

10. The system of claim 9, wherein the interrupt is communicated via one of Inter-Integrated Circuit protocol or master state machine protocol.

11. The system of claim 8, wherein one or more of the plurality of processing cores may be configured to shut down the system in response to the error signal.

12. The system of claim 1, wherein a privilege level of at least one of the plurality of processing cores is indicated by a core identifier of the at least one of the plurality of processing cores.

13. A method comprising, in a system comprising a plurality of processing cores and a target shared among the plurality of processing cores and coupled to the plurality of processing cores via a shared bus:
based on access configuration settings associated with the target, controlling access of requests from each of the plurality of processing cores based on a privilege level of each of the plurality of processing cores, in order to dynamically allocate and re-allocate the target among the plurality of processing cores in accordance with the privilege levels and to dynamically utilize the target in accordance with the privilege levels.

14. The method of claim 13, wherein the plurality of processing cores, the target, and the access control logic are fabricated within the same multicore processor integrated circuit.

15. The method of claim 13, wherein at least one of the processing cores and the target are fabricated on different integrated circuits.

16. The method of claim 15, wherein:
the target is fabricated on a first integrated circuit;
a processing core is fabricated on a second integrated circuit coupled to the first integrated circuit via an inter-chip communications link; and
the first integrated circuit and the second integrated circuit are configured such that a privilege level of the second integrated circuit is controlled by the first integrated circuit and such that the second integrated circuit is able to overwrite the privilege level.

17. The method of claim 13, wherein controlling access of requests from each of the plurality of processing cores based on the privilege level of each of the plurality of processing cores comprises controlling access from at least one processing core of the plurality of processing cores to the target based on an access mode of the at least one processing core.

18. The method of claim 13, further comprising overriding an access mode of at least one processing core of the plurality of processing cores with at least one other access control parameter and wherein controlling access of requests from each of the plurality of processing cores based on the privilege level of each of the plurality of processing cores comprises controlling access from the at least one processing core based on the at least one other access control parameter.

19. The method of claim 13, wherein controlling access of requests from each of the plurality of processing cores based on the privilege level of each of the plurality of processing cores comprises controlling access from at least one processing core of the plurality of processing cores to the target based on an identifier of the at least one processing core.

20. The method of claim 13, further comprising generating an error signal responsive to disallowing a request from a processing core to the target in accordance with the access configuration settings.

21. The method of claim 20, wherein the error signal is generated as an interrupt to one or more of the plurality of processing cores.

22. The method of claim 21, wherein the interrupt is communicated via one of Inter-Integrated Circuit protocol or master state machine protocol.

23. The method of claim 20, further comprising one or more of the plurality of processing cores shutting down the system in response to the error signal.

24. The method of claim 13, wherein a privilege level of at least one of the plurality of processing cores is indicated by a core identifier of the at least one of the plurality of processing cores.
